(19) United States
(12) Patent Application Publication
(10) Pub. No.: US 2017/0291125 A1
(43) Pub. Date: Oct. 12, 2017

(54) WATER PURIFIER CAPABLE OF AUTOMATIC FLUSHING AND CLEANING

(71) Applicant: Xiamen Runner Industrial Corporation, Xiamen (CN)

(72) Inventor: XIAN-LIANG GUO, Xiamen (CN)

(21) Appl. No.: 15/479,258

(22) Filed: Apr. 4, 2017

(30) Foreign Application Priority Data
Apr. 7, 2016 (CN) 201620279618.0

(51) Int. Cl. B01D 29/66; C02F 1/44; B01D 29/50; B01D 15/08; B01D 61/14; C02F 1/28; C02F 1/00

(52) U.S. Cl. CPC B01D 29/66; C02F 1/283; C02F 1/444; C02F 1/003; B01D 15/08; B01D 61/145; B01D 29/50; C02F 2201/005; C02F 2209/40; C02F 2303/16

(57) ABSTRACT

A water purifier capable of automatic flushing and cleaning, comprising: a fixing seat, on which is provided with a water input channel; a flow meter, disposed on the water input channel; a terminal filtering device, connected to an end of the water input channel; a purified water output channel, disposed on the fixing seat, and is connected to a filter core output port of the terminal filtering device; a waste water output channel, disposed on the fixing seat, and is connected and in communication with an inner chamber of the terminal filtering device, to output waste water produced through flushing a filter core; and a waste water output pulsed solenoid valve, disposed on the waste water output channel. The water purifier is novel in design and compact in structure, and is capable of automatic flushing and cleaning.

### BACKGROUND OF THE INVENTION

### Field of the Invention

The present invention relates to a water purifier, and in particular to a water purifier capable of automatic flushing and cleaning.

### The Prior Arts

Presently, in the process of water purification, an ultra-filtration membrane of an ultra-filtration filter device is used to filter and gather large amount of germs and stores them in a filter bottle. As such, when the ultra-filtration filter device is not used for a long period of time, the germs tend to multiply in large quantity, thus leading to the deterioration of purified water quality, while the water purifier is not capable of purifying water effectively.

Therefore, presently, the design and performance of the water purifier is not quite satisfactory, and it leaves much room for improvement.

### SUMMARY OF THE INVENTION

In view of the problems and drawbacks of the prior art, the present invention provides a water purifier capable of automatic flushing and cleaning, to overcome the shortcomings of the prior art.

The present invention provides a water purifier capable of automatic flushing and cleaning, that is novel in design and compact in structure, such that the water purifier can be flushed and cleaned automatically.

The present invention provides a water purifier capable of automatic flushing and cleaning, that includes: a fixing seat, a flow meter, a terminal filtering device, a purified water output channel, a waste water output channel, and a waste water output pulsed solenoid valve. The fixing seat is provided with a water input channel thereon, while the flow meter is disposed on the water input channel. The terminal filtering device is connected to an end of the water input channel. The purified water output channel is disposed on the fixing seat, and is connected to a filter core output port of the terminal filtering device. The waste water output channel is disposed on the fixing seat, and is connected to and in communication with an inner chamber of the terminal filtering device, to output waste water produced through flushing the filter core. The waste water output pulsed solenoid valve is disposed on the waste water output channel.

In an aspect of the present invention, the water purifier capable of automatic flushing and cleaning further includes: a first filtering device and a second filtering device, disposed on the water input channel, and in front of the terminal filtering device; and a water cutoff pulsed solenoid valve, disposed between the first filtering device and the second filtering device.

In another aspect of the present invention, the water purifier capable of automatic flushing and cleaning further includes: a raw water input port, disposed at one side of the fixing seat and is connected to raw water; and a first filter core water input interface and a first filter core water output interface, disposed at a lower end of the fixing seat, and in a water input direction along the water input channel in sequence, with their openings facing downward, to connect respectively to a water input port and a water output port of the first filtering device and the second filtering device.

In yet another aspect of the present invention, the water purifier capable of automatic flushing and cleaning further includes: a second filter core water input interface, disposed at a lower portion on the other side of the fixing seat, to connect and in communication with the water input channel, and a filter core input port of the terminal filtering device; a second filter core water output interface, disposed to connect and in communication with a filter core output port of the terminal filtering device, and a purified water output channel; and a third filter core water output interface, disposed to connect the inner chamber of the terminal filtering device and the waste water output channel.

In a further aspect of the present invention, the first filtering device is a plaited paper or PP cotton filtering device, the second filtering device is an active carbon filtering device, and the terminal filtering device is an ultra-filtration filter device.

In another aspect of the present invention, the water purifier capable of automatic flushing and cleaning further includes: a flow guiding tube, disposed on the filter core input port of the terminal filtering device, and is connected to a lower portion of the inner chamber of the terminal filtering device.

In yet another aspect of the present invention, the water cutoff pulsed solenoid valve is provided, with its operations depending on a service life of the filter core, the flow meter is disposed in the water input channel between a first filter core and a second filter core, while on the fixing seat is provided with a water purifier condition indicator.

Compared with the existing technology, the present invention has the advantage in that, it is novel in design and compact in structure, while the water purifier can be flushed and cleaned automatically. The present invention is of high integration and has wide scope of application, thus having a good prospect in the market.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

The related drawings in connection with the detailed descriptions of the present invention to be made later are described briefly as follows, in which:

FIG. 1 is a schematic diagram of a water purifier capable of automatic flushing and cleaning according to an embodiment of the present invention;

FIG. 2 is a cross section view of a water purifier capable of automatic flushing and cleaning according to an embodiment of the present invention;

FIG. 3 is an enlarged view of a region A of FIG. 2 for a water purifier capable of automatic flushing and cleaning according to an embodiment of the present invention;

FIG. 4 is a cross section view of a water purifier capable of automatic flushing and cleaning, while performing flushing according to an embodiment of the present invention; and

FIG. 5 is an enlarged view of a region B of FIG. 4 for a water purifier capable of automatic flushing and cleaning according to an embodiment of the present invention.

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

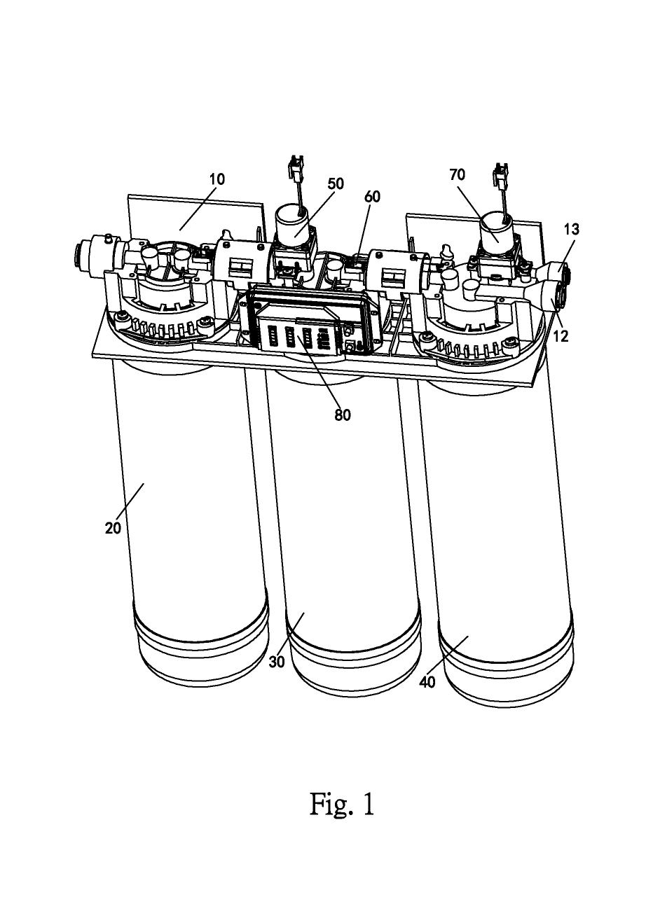

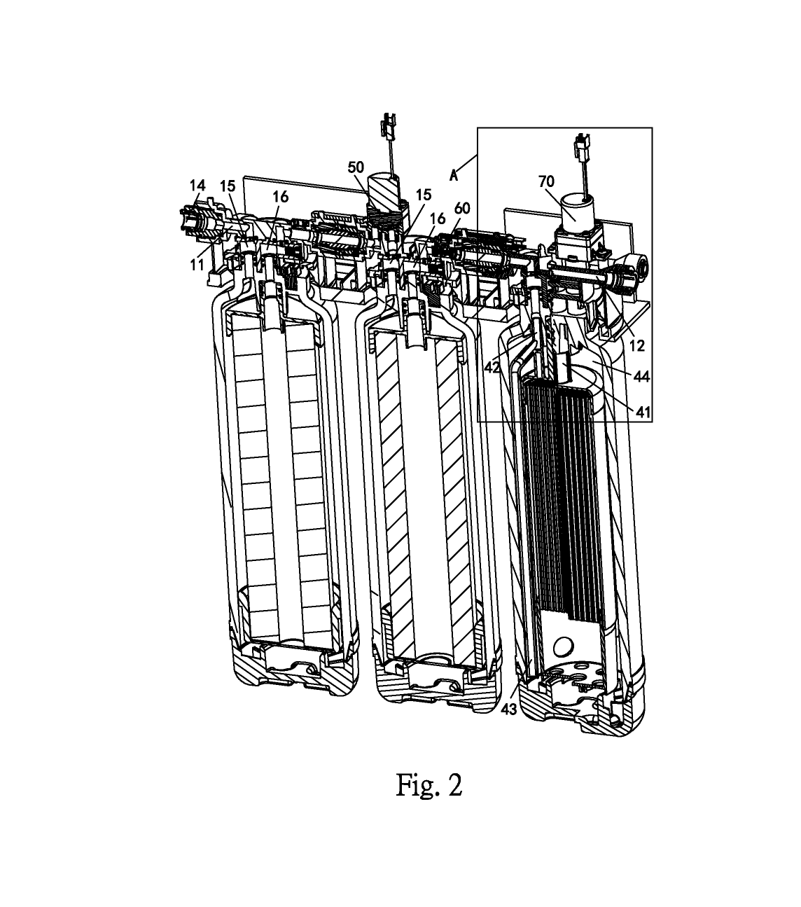

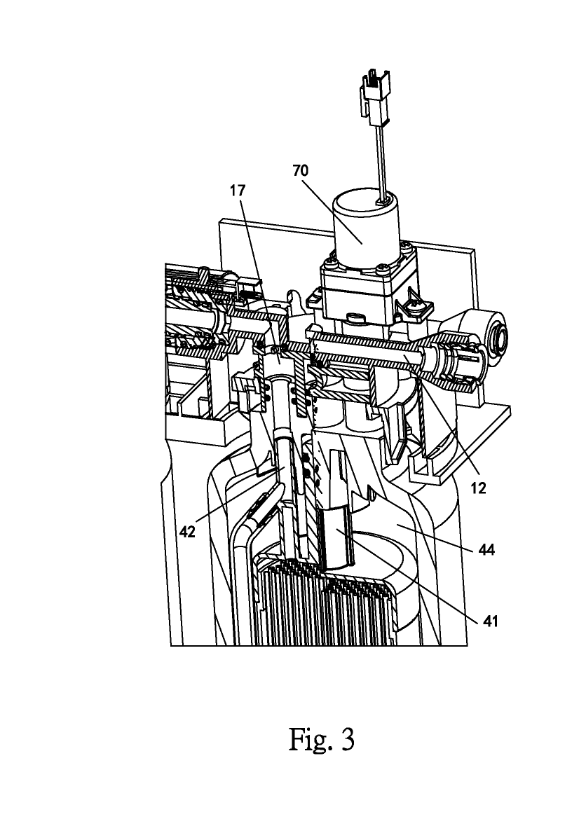

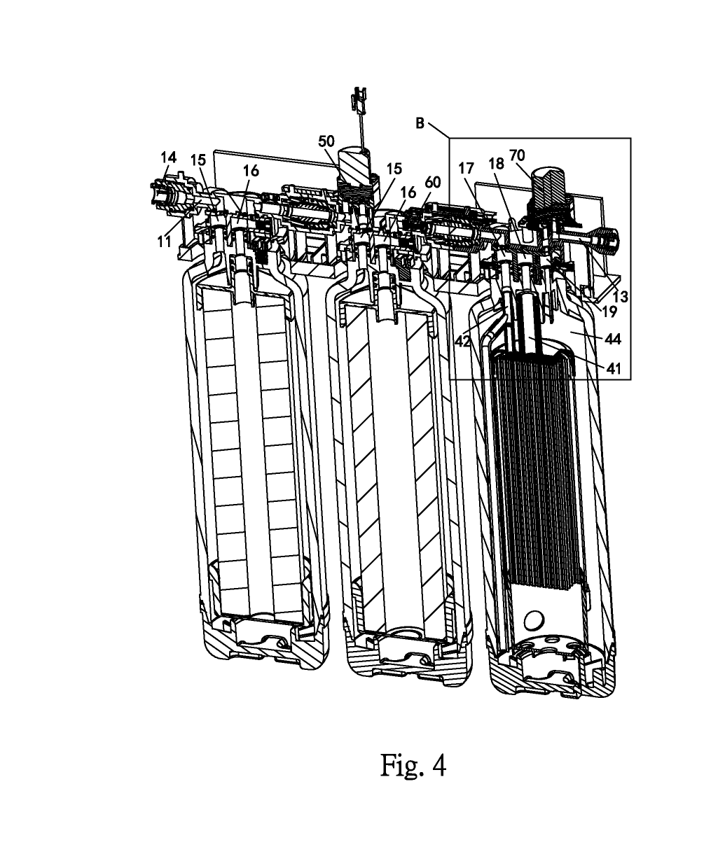

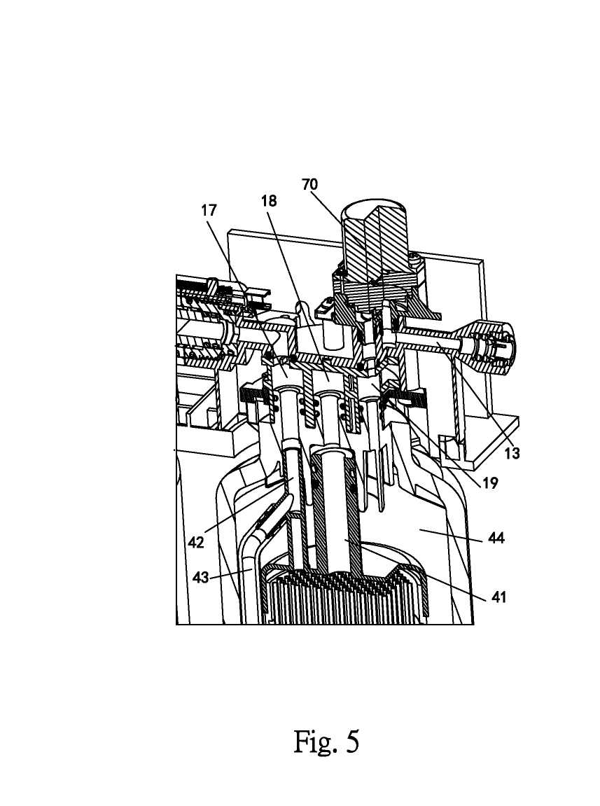

Refer to FIGS. 1 to 5 respectively for a schematic diagram of a water purifier capable of automatic flushing and cleaning according to an embodiment of the present invention; a cross section view of a water purifier capable of automatic flushing and cleaning according to an embodiment of the present invention; an enlarged view of a region A of FIG. 2 for a water purifier capable of automatic flushing and cleaning according to an embodiment of the present invention; a cross section view of a water purifier capable of automatic flushing and cleaning, while performing flushing according to an embodiment of the present invention; and an enlarged view of a region B of FIG. 4 for a water purifier capable of automatic flushing and cleaning according to an embodiment of the present invention.

As shown in FIGS. 1 to 5, the present invention provides a water purifier capable of automatic flushing and cleaning, that includes: a fixing seat 10, a flow meter 60, a terminal filtering device 40, a purified water output channel 12, a waste water output channel 13, and a waste water output pulsed solenoid valve 70. The fixing seat 10 is provided with a water input channel 11 thereon, while the flow meter 60 is disposed on the water input channel 11. The terminal filtering device 40 is connected to an end of the water input channel 11. The purified water output channel 12 is disposed on the fixing seat 10, and is connected to a filter core output port 41 of the terminal filtering device 40. The waste water output channel 13 is disposed on the fixing seat 10, and is connected to and in communication with an inner chamber 44 of the terminal filtering device 40, to output waste water produced through flushing the filter core. The waste water output pulsed solenoid valve 70 is disposed on the waste water output channel 13, to effect connection and disconnection of the waste water output channel 13.

In an embodiment of the present invention, the water purifier capable of automatic flushing and cleaning further includes: a first filtering device 20 and a second filtering device 30, disposed on the water input channel 11, and in front of the terminal filtering device 40; and a water cutoff pulsed solenoid valve 50, disposed between the first filtering device 20 and the second filtering device 30. The operation of the water cutoff pulsed solenoid valve 50 depends on the service life of the filter core, such that when the service life of the filter core is reached, the water purifying process will be stopped automatically.

In an embodiment of the present invention, the water purifier capable of automatic flushing and cleaning further includes: a raw water input port 14, disposed at one side of the fixing seat 10 and is connected to raw water; and a first filter core water input interface 15 and a first filter core water output interface 16, disposed at a lower end of the fixing seat 10, and in a water input direction along the water input channel 11 in sequence, with their openings facing downward, to connect respectively to a water input port and a water output port of the first filtering device 20 and the second filtering device 30. As such, when the raw water is input through the raw water input port 14, the raw water is transported to the filter core of the first filtering device 20 via the first filter core water input interface 15. After filtering, the filtered water is transported back to the water input channel 11 through the first filter core water output interface 16. Then, the filtered water is transported to the second filtering device 30 for further filtering. Subsequently, the filtered water is transported to the terminal filtering device 40 for filtering via the flow meter 60.

In an embodiment of the present invention, the water purifier capable of automatic flushing and cleaning further includes: a second filter core water input interface 17, disposed at a lower portion on the other side of the fixing seat 10, to connect and in communication with the water input channel, and a filter core input port 42 of the terminal filtering device 40; a second filter core water output interface 18, disposed to connect and in communication with a filter core output port 41 of the terminal filtering device 40, and a purified water output channel 12; and a third filter core water output interface 19, disposed to connect the inner chamber 44 of the terminal filtering device 40 and the waste water output channel 13.

In an embodiment of the present invention, the first filtering device 20 is a plaited paper or PP cotton filtering device, the second filtering device 30 is an active carbon filtering device, and the terminal filtering device 40 is an ultra-filtration filter device.

In an embodiment of the present invention, the water purifier capable of automatic flushing and cleaning further includes: a flow guiding tube 43, disposed on the filter core input port 42 of the terminal filtering device 40, and is connected to a lower portion of the inner chamber 44 of the terminal filtering device 40. As such, the water filtered through the first filtering device 20 and the second filtering device 30 is transported to the bottom portion of the terminal filtering device 40.

In an embodiment of the present invention, the water cutoff pulsed solenoid valve 50 is provided, with its operations depending on a service life of the filter core. The flow meter 60 is disposed in the water input channel 11 between a first filter core and a second filter core, to monitor and record the purified water amount; while on the fixing seat 10 is provided with a water purifier condition indicator 80.

The operation principles of the water purifier are described in detail as follows:

### The Water Purifying Process

The waste water output pulsed solenoid valve 70 is activated to close the waste water output channel 13, so that raw water is transported to the first filtering device 20 through the water input channel 11. After filtering, it is transported to the second filtering device 30. Then, the filtered water is sent to the terminal filtering device 40 for further filtering via the flow guiding tube 43. Finally, the purified water is output from the purified water output channel 12 through the second filter core water output interface 18.

### The Water Flushing Process

The waste water output pulsed solenoid valve 70 is activated to open the waste water output channel 13, so that raw water filtered through the first filtering device 20 and the second filtering device 30 is transported to the terminal filtering device 40 to flush the filter core contained therein, the waste water thus produced is exit and output from the waste water output channel 13.

When the filter core of the filtering device reaches the end of its service life, the water cutoff pulsed solenoid valve 50 closes the water input channel 11, to stop the water filtering process. In the water filtering process and the filter core flushing process, the flow meter 60 monitors and records continuously the water flowing through the water purifier. In addition, the flow meter 60 detects if water indeed flows through the water purifier. In case, it detects no water flows through the water purifier for a preset period of time, it will trigger the flushing operation to flush and clean the filter core of the water purifier automatically.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A water purifier capable of automatic flushing and cleaning, comprising:
a fixing seat, on which is provided with a water input channel;
a flow meter, disposed on the water input channel;
a terminal filtering device, connected to an end of the water input channel;
a purified water output channel, disposed on the fixing seat, and is connected to a filter core output port of the terminal filtering device;
a waste water output channel, disposed on the fixing seat, and is connected and in communication with an inner chamber of the terminal filtering device, to output waste water produced through flushing a filter core; and
a waste water output pulsed solenoid valve, disposed on the waste water output channel.

2. The water purifier capable of automatic flushing and cleaning as claimed in claim 1, further comprising:
a first filtering device and a second filtering device, disposed on the water input channel, and in front of the terminal filtering device; and
a water cutoff pulsed solenoid valve, disposed between the first filtering device and the second filtering device.

3. The water purifier capable of automatic flushing and cleaning as claimed in claim 2, further comprising:
a raw water input port, disposed at one side of the fixing seat and is connected to raw water; and
a first filter core water input interface and a first filter core water output interface, disposed at a lower end of the fixing seat, and in a water input direction along the water input channel in sequence, with their openings facing downward, to connect respectively to a water input port and a water output port of the first filtering device and the second filtering device.

4. The water purifier capable of automatic flushing and cleaning as claimed in claim 3, further comprising:
a second filter core water input interface, disposed at a lower portion on the other side of the fixing seat, to connect and in communication with the water input channel, and a filter core input port of the terminal filtering device;
a second filter core water output interface, disposed to connect and in communication with a filter core output port of the terminal filtering device, and a purified water output channel; and
a third filter core water output interface, disposed to connect the inner chamber of the terminal filtering device and the waste water output channel.

5. The water purifier capable of automatic flushing and cleaning as claimed in claim 2, wherein the first filtering device is a plaited paper or PP cotton filtering device, the second filtering device is an active carbon filtering device, and the terminal filtering device is an ultra-filtration filter device.

6. The water purifier capable of automatic flushing and cleaning as claimed in claim 4, further comprising: a flow guiding tube, disposed on the filter core input port of the terminal filtering device, and is connected to a lower portion of the inner chamber of the terminal filtering device.

7. The water purifier capable of automatic flushing and cleaning as claimed in claim 2, wherein the water cutoff pulsed solenoid valve is provided, with its operations depending on a service life of the filter core, the flow meter is disposed in the water input channel between a first filter core and a second filter core, while on the fixing seat is provided with a water purifier condition indicator.
